(19) United States
(12) Patent Application Publication
(10) Pub. No.: US 2015/0260879 A1
(43) Pub. Date: Sep. 17, 2015

(54) TETHERSONDE SYSTEM AND OBSERVATION METHOD THEREBY

(71) Applicant: Electronics and Telecommunications Research Institute, Daejeon (KR)

(72) Inventor: Hong-Soon NAM, Daejeon (KR)

(21) Appl. No.: 14/448,331

(22) Filed: Jul. 31, 2014

(30) Foreign Application Priority Data
Mar. 12, 2014 (KR) 10-2014-0029093

(51) Int. Cl. G01W 1/08

(52) U.S. Cl. CPC G01W 1/08

(57) ABSTRACT

The present invention provides a tethersonde system and an observation method thereby. The tethersonde system comprises a balloon, a radiosonde observing weather while being carried aloft by the balloon and transmitting weather data including position information, a ground receiver receiving and analyzing the weather data and determining wind direction and speed of the atmospheric layer using the position information, and a connection line connecting the ground receiver and the radiosonde and being wound or unwound to control an observation point of the radiosonde.

### CROSS REFERENCE TO RELATED APPLICATION

This application claims priority to and the benefit of Korean Patent Application No. 10-2014-0029093, filed on Mar. 12, 2014, entitled “Tethersonde system and observation method thereby”, which is hereby incorporated by reference in its entirety into this application.

### BACKGROUND OF THE INVENTION

1. Technical Field

The present invention relates to a tethersonde system and an observation method thereby.

2. Description of the Related Art

A radiosonde for upper air observation is carried aloft by the balloon and measures and transmits weather data to a ground receiver as it ascends. The radiosonde is equipped with sensors such as a thermometer, a hygrometer, and a barometer, a GPS receiver, and a wireless transmitter. It periodically measures weather information as it ascends and wirelessly transmits the result. The ground receiver receives weather data from the radiosonde and analyzes and stores the data. The balloon to lift the radiosonde is filled with a light gas and rises in accordance with buoyant force. However, as the balloon ascends, it expands and eventually bursts, and then it falls to the ground with the radiosonde. Once the radiosonde falls down to an unspecified area such as mountain or sea, it cannot be used for recalibration and recovery and is thus discarded.

In order to resolve such a problem, a parachute having a plurality of control lines and driving such control lines are applied to a radiosonde to recover radiosonde and balloon without damages by estimating a drop point. However, as weight of the device lifted up through the atmosphere increase, it may not be suitable for the low and middle atmospheric observation, may make environment pollution worse when it is not recovered due to atmospheric conditions, and may increase risks of accidents.

On the other hand, a tethersonde system, of which a tethersonde and a balloon are attached to the ground by a connection line, is used to measure the low and middle atmospheric weather (temperature, humidity, air pressure, wind speed, wind direction, etc.). The tethersonde of the tethersonde system can be recovered by winding a connection line when the observation is completed. Thus, it allows repeated measurement by winding and unwinding the line and controlling measurement time. However, since unlike the radiosonde, the tethersonde tethered by a connection line cannot move along the wind, it requires additional anemoscope and anemometer to observe wind. In addition, it may be difficult to use the tethersonde when the wind is strong since it is tethered, and to measure weather at altitudes higher than the middle layer due to heavier weight and higher volume than the radiosonde.

In order to resolve such problems associated the above-mentioned tethersonde, a tension-meter is equipped to a tethersonde to measure wind direction and wind speed without having an anemoscope and/or an anemometer in which the wind direction and speed are measured by determining string tension of a connection line and position of the balloon. This tethersonde can utilize a radiosonde and facilitate measurement due to easy moving. However, when wind is strong, observation may be difficult due to the tension-meter tethered by a connection line. In addition, when wind force changes, the balloon may keep moving and a part of the wind force may be consumed for the kinetic energy. Thus, it may cause errors in wind speed which is calculated using the string tension.

### SUMMARY OF THE INVENTION

The present invention is to provide a tethersonde system to measure the low and middle atmospheric weather by applying a connection line to a radiosonde to recover the radiosonde after use.

According to an aspect of the present invention, there is provided a tethersonde system.

A tethersonde system according to an embodiment of the present invention comprises a balloon; a radiosonde observing weather while being carried aloft by the balloon and transmitting weather data including position information; a ground receiver receiving and analyzing the weather data and determining wind direction and speed of the atmospheric layer using the position information; and a connection line connecting the ground receiver and the radiosonde and being wound or unwound to control an observation point of the radiosonde.

The ground receiver determines the wind direction and speed from a position vector using the position information during the radiosonde rises, or determines the wind direction and speed from azimuth angle and elevation angle using the position information when the radiosonde is suspended by the connection line.

The position information comprises longitude, latitude and altitude of the point where the radiosonde is located and the ground receiver converts the position information to a spherical coordinate system and, when the distance between the point of the radiosonde at a previous time t−1 or at a current time t and the reference point is different from a fixed length, determines the wind speed by using a horizontal distance between the point of the radiosonde at a previous time t−1 and the point at a current time t and a measurement period which is difference between the measurement time at the previous time t−1 and the measurement time at the current time t, and determines the wind direction by using difference between xy coordinate of the point of the radiosonde at a previous time t−1 and xy coordinate of the point of the radiosonde at a current time t.

The ground receiver determines the wind speed by subtracting lift speed of the radiosonde from the value calculated by using difference between altitude of the point of the radiosonde at a previous time t−1 and altitude of the point of the radiosonde at a current time t and the measurement period.

The ground receiver determines the wind speed by using (1) equilibrium of net force between lift force by the balloon and horizontal pulling force of the wind with string tension of the connection line, and (2) altitude of the radiosonde which varies with intensity of the wind, and determines the wind direction by using an azimuth angle at the point of the radiosonde at a current time t when the distance between the point of the radiosonde at a previous time t−1 and at a current time t and the reference point is identical to a fixed length and current point of the radiosonde is identical to previous point of the radiosonde.

The ground receiver determines the wind speed by using (1) being equilibrium of forces of lift force by the balloon, horizontal pulling force of the wind, drag force on the moving speed and force of mass acceleration of the radiosonde with string tension of the connection line, and (2) altitude of the radiosonde which varies with intensity of the wind, and determines the wind direction by using an azimuth angle at the point of the radiosonde at a current time t when the distance between the point of the radiosonde at a previous time t−1 and at a current time t and the reference point is identical to a fixed length and current point of the radiosonde is different from previous point of the radiosonde.

The ground receiver comprises a balloon elevation module winding/unwinding the connection line, wherein the balloon elevation module controls observing point or observing time by adjusting the length of the connection line.

The tethersonde system further comprises a parachute device unfolding the parachute and being connected to the radiosonde to reduce a falling speed when the radiosonde falls due to burst of the balloon.

The connection line comprises a tether connection line, a radiosonde connection line and a balloon connection line, wherein the radiosonde connection line or the balloon connection line is pre-controlled to be broken in a severe windy weather to convert the tethersonde system to a radiosonde system to be used or to recover the radiosonde.

According to another aspect of the present invention, there is provided an observation method performed by a ground receiver in a tethersonde system in which the ground receiver is connected to a radiosonde, observing weather as a balloon ascends, by a connection line.

An observation method in a tethersonde system according to an embodiment of the present invention comprises: controlling an observation point of the radiosonde by winding or unwinding the connection line; receiving weather data comprising position information from the radiosonde; analyzing the weather data; and determining wind direction and speed of a corresponding atmospheric layer by using the position information.

The step of determining wind direction and speed comprises: calculating the wind direction and speed from a position vector using the position information during the radiosonde ascends; and calculating the wind direction and speed from azimuth angle and elevation angle using position information when the radiosonde is suspended by the connection line.

The step of determining the wind direction and speed from a position vector comprises: converting the position information into a spherical coordinate system; calculating the wind speed by using horizontal distance between the point of the radiosonde at a previous time t−1 and the point at a current time t and measurement period which is difference between the measurement time at the previous time t−1 and the measurement time at the current time t when distance between the point of the radiosonde at a previous time t−1 or at a current time t and the reference point is different from a fixed length; and calculating the wind direction by using difference between xy coordinate of the point of the radiosonde at a previous time t−1 and xy coordinate of the point of the radiosonde at a current time t.

The observation method further comprises calculating the wind speed by subtracting lift speed of the radiosonde from the value calculated by using difference between altitude of the point of the radiosonde at a previous time t−1 and altitude of the point of the radiosonde at a current time t and the measurement period when the wind blows in the vertical direction.

The step of calculating the wind direction and speed from azimuth angle and elevation angle comprises when the distance between the point of the radiosonde at a previous time t−1 and at a current time t and the reference point is identical to a fixed length and current point of the radiosonde is identical to previous point of the radiosonde: calculating the wind speed by using (1) equilibrium of net force between lift force by the balloon and horizontal pulling force of the wind with string tension of the connection line, and (2) altitude of the radiosonde which varies with intensity of the wind; and calculating the wind direction by using an azimuth angle at the point of the radiosonde at a current time t.

The step of calculating the wind direction and speed from azimuth angle and elevation angle comprises when the distance between the point of the radiosonde at a previous time t−1 and at a current time t and the reference point is identical to a fixed length and current point of the radiosonde is different from previous point of the radiosonde: calculating the wind speed by using (1) being equilibrium of forces of lift force by the balloon, horizontal pulling force of the wind, drag force on the moving speed and force of mass acceleration of the radiosonde with string tension of the connection line, and (2) altitude of the radiosonde which varies with intensity of the wind; and calculating the wind direction by using an azimuth angle at the point of the radiosonde at a current time t.

The tethersonde system of the present invention can be functioned as a radiosonde or a tethersonde.

### BRIEF DESCRIPTION OF THE DRAWING

FIG. 1 is a schematic view illustrating a tethersonde system.

FIG. 2 is a flowchart illustrating an observation method in the tethersonde system of FIG. 1.

FIG. 3 illustrates a position coordinate of a radiosonde in the spherical coordinate system.

FIG. 4 illustrates forces that affect the radiosonde where a radiosonde moves on the surface of the sphere.

FIG. 5 is a schematic view illustrating a tethersonde system.

### DESCRIPTION OF THE EXEMPLARY EMBODIMENTS

While the present invention has been described with reference to particular embodiments, it is to be appreciated that various changes and modifications may be made by those skilled in the art without departing from the spirit and scope of the present invention, as defined by the appended claims and their equivalents.

Throughout the description of the present invention, when describing a certain technology is determined to evade the point of the present invention, the pertinent detailed description will be omitted. In addition, the numbers used in the description may be used to describe various components and are used only to distinguish one component from another.

When one element is described as being “connected” or “accessed” to another element, it shall be construed as being connected or accessed to the other element directly but also as possibly having another element in between.

Hereinafter, certain embodiments of the present invention will be described with reference to the accompanying drawings, in which components are rendered the same reference number that are the same or are in correspondence, regardless of the figure number, and redundant explanations are omitted.

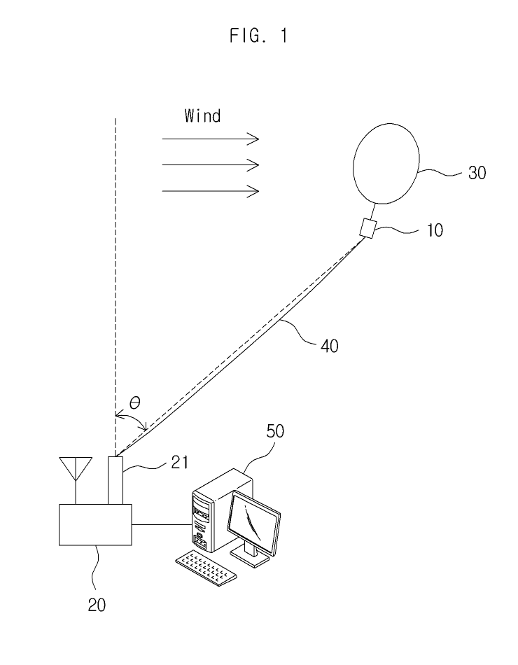

FIG. 1 is a schematic view illustrating a tethersonde system.

Referring to FIG. 1, a tethersonde system comprises a radiosonde 10, a ground receiver 20, a balloon 30, a connection line 40 and a user terminal 50.

The radiosonde 10 is carried aloft by the balloon 30, periodically measures weather, and transmits the measured weather data to the ground receiver 20. For example, the radiosonde 10 is to observe upper air weather up to about 35 km from the ground and is equipped with sensors that measure temperature, humidity, air pressure and the like and a GPS receiver. The radiosonde 10 may transmit weather data including position information which is obtained through the GPS receiver to the ground receiver 20 in which the position information may be used to estimate wind direction and speed.

The ground receiver 20 analyzes and stores the weather data received from the radiosonde 10 and then transmits the result to the user terminal 50.

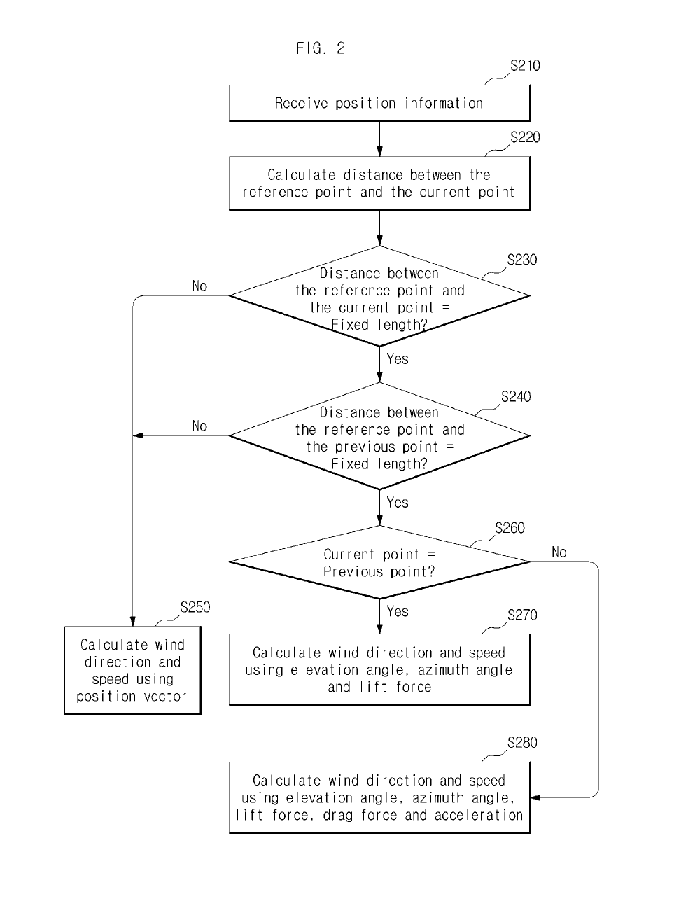

Particularly, the ground receiver 20 may determine wind direction and speed of a corresponding atmospheric layer by using the position information included in the weather data received from the radiosonde 10. For example, the ground receiver 20 determines wind direction and speed from a position vector by using the position information during the radiosonde 10 ascends with the balloon 30, while it does wind direction and speed from azimuth angle and elevation angle by using the position information when the radiosonde 10 is suspended by the connection line 40. It will be explained in detail with reference to FIG. 2 to FIG. 4.

The ground receiver 20 comprises a balloon elevation module 21 to wind or unwind the connection line 40. For example, the balloon elevation module 21 may be an electric reel to lift the balloon 30 and the radiosonde 10 from the ground to the low and middle atmospheric layer by automatically or manually winding or unwinding the connection line 40 connected to the balloon 30 and/or the radiosonde or to drop the balloon 30 and the radiosonde 10 from the low and middle atmospheric layer to the ground after observation. In addition, the balloon elevation module 21 may control observing point or observing time by adjusting the length of the connection line 40.

The balloon 30 filled with a light gas ascends by buoyant force, expands and eventually bursts. When the balloon 30 bursts, the radiosonde 10 falls down to the ground. For example, the radiosonde 10 may be attached to a parachute device 11 which allows the balloon package to drift back gently.

After observation, the connection line 40 is used to recover the balloon 30 and the radiosonde 10. The length of the connection line 40 may be controlled by winding or unwinding the line with a balloon elevation module 21. When the connection line 40 is released up to a certain length which is fixed for a certain period of time, it is called as a fixed length which can be changed by an operator. For example, a fixed length can be determined to correspond to altitude of an observing point or the maximum length of the connection line 40.

FIG. 2 is a flowchart illustrating an observation method in the tethersonde system of FIG. 1.

In S210, the ground receiver 20 receives position information from the radiosonde 10. Here, the position information includes latitude, longitude and altitude of current point of the radiosonde 10. The ground receiver 20 may convert the position information to a spherical coordinate system to calculate wind direction and speed.

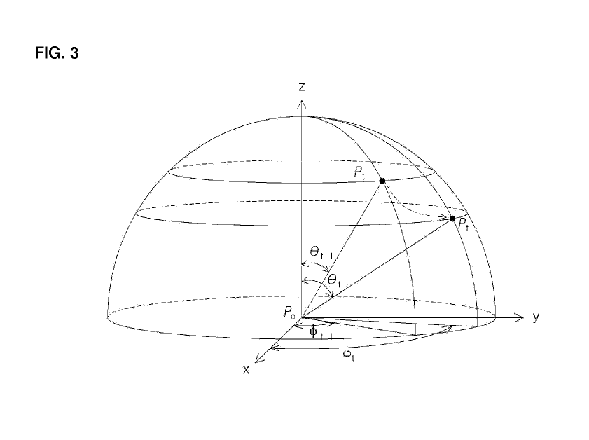

For example, FIG. 3 illustrates a position coordinate of a radiosonde in the spherical coordinate system.

Referring to FIG. 3, the spherical coordinate system includes the radius which is a fixed length, r, longitude (east-west direction), x-axis; latitude (south-north direction), y-axis; and altitude, z-axis. The tethersonde is released at the origin point at time 0 of which the spherical coordinate system is P₀(x, y, z), and after a time t (eg., 10 hours), the tethersonde is at a position of Pₜ(x, y, z). The spherical coordinate system further includes the elevation angle, θₜ, and the azimuth angle, φₜ.

For example, the elevation angle (θ) and the azimuth angle (φ) may be calculated from the following Equation 1.

θ=tan⁻¹((x²+y²)^{1/2}/z)

φ=tan⁻¹(y/x) [Equation 1]

At a time, t−1 (previous time as much as a pre-determined measurement period from current time), the spherical coordinate of a position of the radiosonde 10 may be Pₜ₋₁(x, y, z) with the elevation angle θₜ₋₁ and the azimuth angle φₜ₋₁.

As shown in FIG. 3, the radiosonde 10 is moved from Pₜ₋₁(x, y, z) at a time t−1 to Pₜ(x, y, z) at a time, t.

In S220, the ground receiver 20 calculates the distance between the reference point and the current point, in which the reference point is the point where the ground receiver 20 is, and the origin point at the spherical coordinate system.

For example, the distance (Dₜ) between Pₜ(x, y, z) of the current point and P₀(x, y, z) of the reference point may be calculated by the following Equation 2 as the difference between the current point and the reference point.

Dₜ=(x²+y²+z²)^{1/2} [Equation 2]

Here, where the connection line 40 is equal to its fixed length (L_{fix}) or within the margin of error, it is assumed that the tethersonde is on the surface of the sphere.

In S230, the ground receiver 20 determines if the distance between the current point of the radiosonde 10 and the reference point is equal to a fixed length. For example, the ground receiver 20 determines that the distance between the current point of the radiosonde 10 and the reference point is equal to a fixed length when it is equal to a fixed length or within the margin of pre-determined error.

When the distance between the current point of the radiosonde 10 and the reference point is not equal to a fixed length, it proceeds to S250.

In S240, the ground receiver 20 determines if the distance between the previous point of the radiosonde 10 and the reference point is equal to a fixed length.

When the distance between the previous point of the radiosonde 10 and the reference point is not equal to a fixed length, it proceeds to S250.

In S250, the ground receiver 20 calculates wind direction and speed using position vector when the distance between the previous point or current point of the radiosonde 10 and the reference point is not equal to a fixed length.

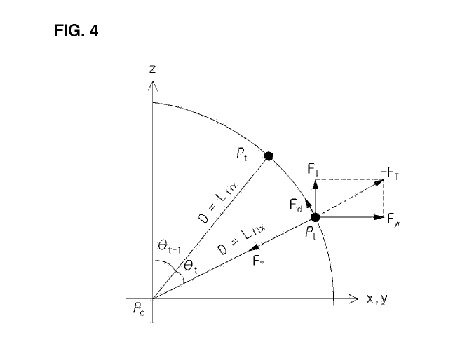

For example, FIG. 4 illustrates forces that affect the radiosonde where a radiosonde moves on the surface of the sphere.

Referring to FIG. 4, when the connection line 40 is released as the radiosonde 10 ascends with the balloon 30, the radiosonde 10 rises by lift force caused by buoyant force and wind force. When it is assumed that the lift force of the vertical direction with ignoring the wind effect is Fₗ, the lift force (Fₗ) may be expressed by Fₗ²=F_{b}²−mg², wherein F_{b} is buoyant force and mg is the gravity force of the balloon and the radiosonde. When it is assumed that the weight of the connection line is light enough, it may be ignored. However, if it is not, the weight of the connection line may be added to mg. The weight of the connection line can be calculated by multiplying weight per unit length and the length. The buoyant force (F_{b}) can be calculated from difference between density of the gas filled in the balloon 30 and density of air, and volume of the balloon 30. Such parameters may be available. After a time t, the lift force (Fₗ) and the drag force (F_{d}) become the same as Fₗ=−F_{d}. Here, the radiosonde 10 rises at a constant speed. The drag force (F_{d}) can be calculated from Fₗ=½ρAC_{d}Vₗ², in which a drag coefficient is C_{d}, the lift speed of the radiosonde 10 is Vₗ, ρ is density of air, and A is the cross sectional area of the balloon.

On the other hand, when the length of the connection line 40 is long enough, the radiosonde 10 moves along with wind. Here, horizontal wind speed (V_{w}) and direction (Dir) can be calculated by the following Equation 3.

V_{w}=∥pₜ(x,y)−pₜ₋₁(x,y)∥/T

Dir=tan⁻¹[(pₜ(y)−pₜ₋₁(y))/(pₜ(x)−pₜ₋₁(x))] [Equation 3]

Here, ∥pₜ(x,y)−pₜ₋₁(x,y))∥ is a horizontal distance between two points in x-y coordinate and T is the difference between time t and t−1 as a measurement period.

Lift speed is Vₕ in vertical direction wind and expressed by Vₕ=(pₜ(z)−pₜ₋₁(z))/T−Vₗ, in which when Vₕ is positive, it becomes a vertical lift speed, while Vₕ is negative, it becomes a vertical descend speed.

In S260, the ground receiver 20 determines if the current point of the radiosonde 10 is identical to the previous point when the distance between the previous point of the radiosonde 10 and the current point is equal to a fixed length.

In S270, the ground receiver 20 calculates wind direction and speed using elevation angle, azimuth angle and lift force when the current point of the radiosonde 10 is identical to the previous point. The ground receiver 20 calculates wind speed by using (1) equilibrium of net force between lift force by the balloon and horizontal pulling force of the wind with string tension of the connection line, and (2) altitude of the radiosonde which varies with intensity of the wind, and also calculates wind direction by using an azimuth angle at the point of the radiosonde at a current time t.

In S280, the ground receiver 20 calculates wind direction and speed using elevation angle, azimuth angle, lift force, drag force and acceleration when the current point of the radiosonde 10 is not identical to the previous point. The ground receiver 20 calculates wind speed by using (1) being equilibrium of forces of lift force by the balloon, horizontal pulling force of the wind, drag force on the moving speed and force of mass acceleration of the radiosonde with string tension of the connection line, and (2) altitude of the radiosonde which varies with intensity of the wind, and also calculates the wind direction by using an azimuth angle at the point of the radiosonde at a current time t.

For example, referring to FIG. 4, when the connection line 40 is related up to the fixed length and is thus no more unwound in the tethersonde system of FIG. 1, the radiosonde 10 can travels on the surface of the sphere whose radius equals to the length of the connection line 40 due to impact of the wind. When the radiosonde 10 stays at a point on the surface of the sphere (Pₜ(x, y, z)=Pₜ₋₁(x, y, z)), it means that the forces, which affect to the radiosonde 10, is in equilibrium. When it is assumed that horizontal wind is caused, relationship between forces can be represented by F_{T}²=Fₗ²+F_{w}², in which F_{w} is horizontal wind force and F_{T} is string tension pulled by the connection line.

Accordingly, the horizontal wind force (F_{w}) is represented by F_{w}=Fₗ tan θ and the wind speed (V_{w}) can be determined by the following Equation 4.

V_{w}=[2Fₗ tan θ/(ρAC_{d})]^{1/2} [Equation 4]

On the other hand, when wind direction and wind speed changes, the radiosonde 10 moves on the surface of the sphere. When the wind gets stronger, the altitude of the radiosonde 10 becomes lower, while the wind gets weaker, the altitude of the radiosonde 10 becomes higher. In this situation, S280 is processed. In S280, the ground receiver 20 can estimate the intensity of the wind by considering drag force, which acts opposite direction to the movement of the tethersonde, and acceleration varying with the intensity of the wind since the position of the radiosonde 10 changes.

When the radiosonde 10 moves, the relation between acceleration and net force can be represented by the following Equation 5,

[symbol]

=m [symbol] − [symbol] − [symbol] − [symbol] [Equation 5]

wherein, m is mass of the radiosonde 10 and F_{d} is a drag force which acts opposite direction to the movement direction.

Velocity and acceleration of the tethersonde may be calculated by taking into account the measurement period, after observing position change from at time t−1 to at time t. When it is assumed that the wind direction is constant and it can be expressed in the spherical coordinate system, the velocity (Vₛ) and drag force of the air (F_{d}) on the surface of the sphere can be represented by the following Equation 6.

$${\overline{V}}_{s} = R \dot{θ} {a}_{e} \\ {F}_{d} = \frac{1}{2} ρ {C}_{d} {AV}_{s}^{2} \qquad [ Equation 6 ]$$

The acceleration \vec{a} can be expressed by the following Equation 7.

$$m \text{?} = m ( \ddot{r} - r {\dot{θ}}^{2} ) = - mR \text{?} = {F}_{c} cos θ + {F}_{w} sin θ - F - m \text{?} = m ( r \ddot{θ} - 2 \dot{r} \dot{θ} ) = mR \ddot{θ} = - {F}_{c} sin θ - {F}_{w} cos θ - \text{?} \\ \text{?} \text{indicates text missing or illegible when filed} \qquad [ Equation 7 ]$$

The string tension F_{T} and the drag force F_{d} can be expressed by the following Equation 8.

$${F}_{T} = {F}_{c} cos θ + {F}_{w} sin θ - ma \\ {F}_{d} = {F}_{c} sin θ + {F}_{w} cos θ - {ma}_{D} \qquad [ Equation 8 ]$$

Accordingly, the wind force (F_{w}), wind speed (V_{w}) and wind direction (Dir) can be then expressed by the following Equation 9.

$${w}_{} = m - {c}_{} - {T}_{} - {d}_{} \\ {V}_{w} = {[ 2 {F}_{w} / ( ρ A {C}_{d} ) ]}^{1 / 2} \\ Dir = {tan}^{- 1} [ {p}_{t} ( y ) / {p}_{t} ( x ) ] \qquad [ Equation 9 ]$$

When there are both the horizontal direction wind and the vertical direction wind, the radiosonde 10 can ascend faster than the lift speed caused by the lift force during the measurement time. When the radiosonde 10 ascends faster than the speed with which the radiosonde 10 travels along with the surface of the sphere, the speed as much as faster than the lift force can be estimated as a vertical lift speed. On the other hand, when the radiosonde 10 descends along with the surface of the sphere, the descending speed of the wind can be ignored.

When the radiosonde 10 located on the surface of the sphere moves to the inside of the sphere, not along with the surface of the sphere, the lift speed can be calculated by adding the lift speed (V_{b}) caused by the buoyant force and the descending speed caused by the position change.

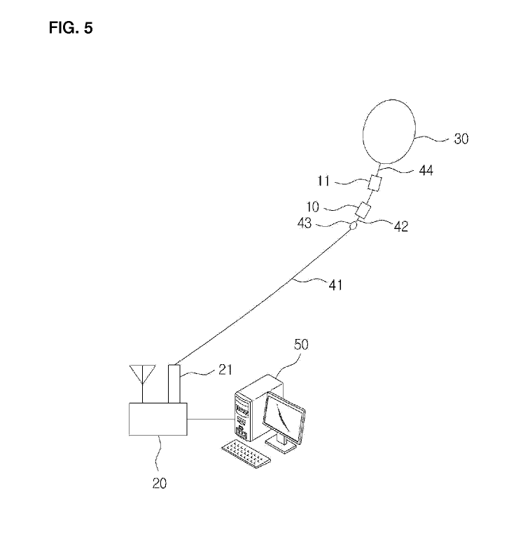

FIG. 5 is a schematic view illustrating a tethersonde system. The connection line 40 of the tethersonde system is explained with reference to FIG. 5. However, overlapping description with the tethersonde system of FIG. 1 will be omitted.

Referring to FIG. 5, the connection line 40 of the tethersonde system includes a tether connection line 41, radiosonde connection line 42 and balloon connection line 44. As shown in FIG. 5, the connection line 40 may further include a tether hole 43 connecting the tether connection line 41 with the radiosonde connection line 42.

The radiosonde connection line 42 or the balloon connection line 44 can be pre-controlled to be broken in a severe windy weather to convert the tethersonde system to a radiosonde system to be used or to recover the radiosonde.

For example, when the tethersonde system is converted to and used as the radiosonde system, the strength of the radiosonde connection line 42 can be controlled to be broken at above pre-determined wind speed. Or, the strength of the radiosonde connection line 42 can be controlled to be weaker than those of other connection lines so that it can be broken by suddenly winding the radiosonde connection line 42 to increase the string tension. When the radiosonde connection line 42 is broken, the radiosonde 10 and the parachute device 11 ascend with the balloon 30 and the balloon 30 expands and eventually bursts. Then, the balloon 30 falls down to the ground. The parachute device 11 may be connected or attached to the radiosonde 10 to reduce the falling speed by being unfolded.

For example, when the balloon 30 is discarded and the radiosonde 10 is recovered, as described above for the radiosonde connection line 42, the strength of the balloon connection line 44 can be controlled to be broken at above pre-determined wind speed. When the balloon connection line 44 is broken, the balloon 30 ascends, bursts, falls and is discarded. The radiosonde 10 and the parachute device 11 can be recovered by winding the tether connection line 41 to pull to the ground receiver 20 during falling. Accordingly, it allows reduction of environmental pollution due to recovery of the radiosonde 10.

While it has been described with reference to particular embodiments, it is to be appreciated that various changes and modifications may be made by those skilled in the art without departing from the spirit and scope of the embodiment herein, as defined by the appended claims and their equivalents. Accordingly, examples described herein are only for explanation and there is no intention to limit the invention.

### DESCRIPTION OF REFERENCE NUMERALS

10: Radiosonde
11: Parachute device
20: Ground receiver
21: Balloon elevation module
30: Balloon
40: Connection line
41: Tether connection line
42: Radiosonde connection line
43: Tether hole
44: Balloon connection line
50: User terminal

What is claimed is:

1. A tethersonde system comprising:
a balloon;
a radiosonde observing weather while being carried aloft by the balloon and transmitting weather data including position information;
a ground receiver receiving and analyzing the weather data and determining wind direction and speed of the atmospheric layer using the position information; and
a connection line connecting the ground receiver and the radiosonde and being wound or unwound to control an observation point of the radiosonde.

2. The tethersonde system of claim 1, wherein the ground receiver determines the wind direction and speed from a position vector using the position information during the radiosonde rises, or determines the wind direction and speed from azimuth angle and elevation angle using the position information when the radiosonde is suspended by the connection line.

3. The tethersonde system of claim 2, wherein the position information comprises longitude, latitude and altitude of the point where the radiosonde is located,
the ground receiver converts the position information to a spherical coordinate system and, when the distance between the point of the radiosonde at a previous time t−1 or at a current time t and the reference point is different from a fixed length, determines the wind speed by using a horizontal distance between the point of the radiosonde at a previous time t−1 and the point at a current time t and a measurement period, which is difference between the measurement time at the previous time t−1 and the measurement time at the current time t, and determines the wind direction by using difference between xy coordinate of the point of the radiosonde at a previous time t−1 and xy coordinate of the point of the radiosonde at a current time t.

4. The tethersonde system of claim 3, wherein the ground receiver determines the wind speed by subtracting lift speed from the value calculated by using difference between altitude of the point of the radiosonde at a previous time t−1 and altitude of the point of the radiosonde at a current time t and the measurement period when the wind blows in a vertical direction.

5. The tethersonde system of claim 3, wherein the ground receiver determines the wind speed by using (1) being equilibrium of net force between lift force by the balloon and horizontal pulling force of the wind with string tension of the connection line, and (2) altitude of the radiosonde which varies with intensity of the wind, and determines the wind direction by using an azimuth angle at the point of the radiosonde at a current time t when the distance between the point of the radiosonde at a previous time t−1 and at a current time t and the reference point is identical to a fixed length, and current point of the radiosonde is identical to previous point of the radiosonde.

6. The tethersonde system of claim 3, wherein the ground receiver determines the wind speed by using (1) being equilibrium of forces of lift force by the balloon, horizontal pulling force of the wind, drag force on the moving speed and force of mass acceleration of the radiosonde with string tension of the connection line, and (2) altitude of the radiosonde which varies with intensity of the wind, and determines the wind direction by using an azimuth angle at the point of the radiosonde at a current time t when the distance between the point of the radiosonde at a previous time t−1 and at a current time t and the reference point is identical to a fixed length and current point of the radiosonde is different from previous point of the radiosonde.

7. The tethersonde system of claim 1, wherein the ground receiver comprises a balloon elevation module winding/unwinding the connection line,
wherein the balloon elevation module controls observing point or observing time by adjusting the length of the connection line.

8. The tethersonde system of claim 1, further comprising a parachute device unfolding the parachute and being connected to the radiosonde to reduce a falling speed when the radiosonde falls due to burst of the balloon.

9. The tethersonde system of claim 1, wherein the connection line comprises a connection line, a radiosonde connection line and a balloon connection line,
wherein the radiosonde connection line or the balloon connection line is pre-controlled to be broken in a severe windy weather to convert the tethersonde system to a radiosonde system to be used or to recover the radiosonde.

10. An observation method in a tethersonde system in an observation method performed by a ground receiver in a tethersonde system in which the ground receiver is connected to a radiosonde, observing weather as a balloon ascends, by a connection line, the observation method comprising:
controlling an observation point of the radiosonde by winding or unwinding the connection line;
receiving weather data comprising position information from the radiosonde;
analyzing the weather data; and
determining wind direction and speed of a corresponding atmospheric layer by using the position information.

11. The observation method of claim 10, wherein the step of determining wind direction and speed comprises:
calculating the wind direction and speed from a position vector using the position information during the radiosonde ascends; and
calculating the wind direction and speed from azimuth angle and elevation angle using position information when the radiosonde is suspended by the connection line.

12. The observation method of claim 11, wherein the step of determining the wind direction and speed from a position vector comprises:
converting the position information into a spherical coordinate system;
calculating the wind speed by using horizontal distance between the point of the radiosonde at a previous time t−1 and the point at a current time t and measurement period which is difference between the measurement time at the previous time t−1 and the measurement time at the current time t when distance between the point of the radiosonde at a previous time t−1 or at a current time t and the reference point is different from a fixed length; and
calculating the wind direction by using difference between xy coordinate of the point of the radiosonde at a previous time t−1 and xy coordinate of the point of the radiosonde at a current time t.

13. The observation method of claim 12, further comprising calculating the wind speed by subtracting lift speed of the radiosonde from the value calculated by using difference between altitude of the point of the radiosonde at a previous time t−1 and altitude of the point of the radiosonde at a current time t and the measurement period when the wind blows in the vertical direction.

14. The observation method of claim 12, wherein the step of calculating the wind direction and speed from azimuth angle and elevation angle comprises when the distance between the point of the radiosonde at a previous time t−1 and at a current time t and the reference point is identical to a fixed length and current point of the radiosonde is identical to previous point of the radiosonde:
calculating the wind speed by using (1) equilibrium of net force between lift force by the balloon and horizontal pulling force of the wind with string tension of the connection line, and (2) altitude of the radiosonde which varies with intensity of the wind; and
calculating the wind direction by using an azimuth angle at the point of the radiosonde at a current time t.

15. The observation method of claim 12, wherein the step of calculating the wind direction and speed from azimuth angle and elevation angle comprises when the distance between the point of the radiosonde at a previous time t−1 and at a current time t and the reference point is identical to a fixed length and current point of the radiosonde is different from previous point of the radiosonde:
calculating the wind speed by using (1) being equilibrium of forces of lift force by the balloon, horizontal pulling force of the wind, drag force on the moving speed and force of mass acceleration of the radiosonde with string tension of the connection line, and (2) altitude of the radiosonde which varies with intensity of the wind; and
calculating the wind direction by using an azimuth angle at the point of the radiosonde at a current time t.
